(19) United States
(12) Patent Application Publication
(10) Pub. No.: US 2006/0094472 A1
(43) Pub. Date: May 4, 2006

(54) Intelligent codec selection to optimize audio transmission in wireless communications

(75) Inventors: Konstantin Othmer, Mountain View, CA (US); Michael P. Ruf, Parkland, FL (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(73) Assignee: Core Mobility, Inc.

(21) Appl. No.: 11/300,522

(22) Filed: Dec. 14, 2005

Related U.S. Application Data
(63) Continuation-in-part of application No. 11/007,700, filed on Dec. 8, 2004.
Application No. 11/007,700 is a continuation-in-part of application No. 10/661,033, filed on Sep. 12, 2003.
Application No. 10/661,033 is a continuation-in-part of application No. 10/407,955, filed on Apr. 3, 2003, now Pat. No. 7,013,155.

(51) Int. Cl. H04B 1/38

(52) U.S. Cl. 455/563

(57) ABSTRACT

An optimal compressor/decompressor (codec) module is intelligently selected for use when transmitting audio from a mobile communication device to a recipient. The codec can be selected based on the type of the audio data or the characteristics of the recipient. The codec can also be selected based on whether the audio data is to be transmitted to the recipient in real time or recorded and transmitted asynchronously. Audio data that is to be transmitted to the recipient is encoded or compressed using the selected codec and then sent to the recipient. Selection of the codec in this manner permits the compression to be optimized in response to specific circumstances associated with the communication of the audio data between the sender device and the recipient. The codec can be selected during the communication in response to a tone or other data provided by the recipient.

### CROSS-REFERENCE TO RELATED APPLICATIONS

This application is a continuation-in-part of U.S. patent application Ser. No. 11/007,700, filed Oct. 20, 2004, which is a continuation-in-part of U.S. patent application Ser. No. 10/661,033, filed Sep. 12, 2003, which claims the benefit of U.S. patent application Ser. No. 10/407,955, filed Apr. 3, 2003, entitled “Delivery of an Instant Voice Message in a Wireless Network Using the SMS Protocol.” The foregoing patent applications are incorporated herein by reference.

### BACKGROUND OF THE INVENTION

1. The Field of the Invention

The present invention relates to optimizing audio quality in wireless communication system transmissions. More particularly, embodiments of the invention relate to selecting and employing the compression/decompression technology most appropriate for the type of data being transmitted and in consideration of the intended recipient of the transmitted data, whether in real-time on a regular call or recorded prior to transmission on a data network in a messaging system.

2. The Relevant Technology

The popularity of all types of mobile communication devices, such as mobile telephones and telephony-enabled personal digital assistants (PDAs), is undeniable. Technological advances in mobile communication devices enable them to be used to conduct multiple types of communication or data transmission. In addition to circuit-switched and packet-switched voice sessions, for example, numerous messaging applications, such as Email, Short Message Service (SMS) messages, Multimedia Messaging Service (MMS) messages, and Instant Messaging (IM) are also available on a wide variety of mobile communication devices. Also, services that provide users with information and updates, such as stock quotes, news alerts and driving directions, or services that improve personal productivity or provide customer services, can all be accessed and engaged via mobile communication devices. Furthermore, multi-media content or other types of entertainment are also accessible via mobile communication devices.

While applications, services, and data that can be accessed via a mobile device deliver significant value to users, their use is limited by the underlying technology that allows them to send and receive audio data. A component of this limitation relates to the way data is compressed and decompressed as it is transmitted over a wireless communication network. Wireless communication devices such as mobile telephones, use codecs (compressor/decompressor) to compress/decompress data.

Codecs can be implemented in software, hardware, or a combination of both, and various codecs exist to handle different types of data, thereby optimizing the efficiency of data transmission and storage. In the case of mobile telephones, the codec {also referred to as a vocoder for “voice coder”} includes a sophisticated algorithm and can be optimized for compressing and decompressing different kinds of audio data. For example, speech data that is intended for a person to hear may use, by way of example and not limitation, the G7.11, AMR, QCELP or EVRC, etc., standards, music data that is intended for a person to hear may utilize MP3 compression. In some systems the codecs can pre-process data such as music that is to be recognized by a music recognition service, or human speech that is to be recognized by a computer performing speech to text or speech recognition.

The standard codecs on mobile communication devices are usually optimized for human speech. As additional applications and services are developed for and/or made accessible by mobile communication devices, specifically those that require communication between a person and a machine rather than between people, the optimal strategy for codec selection changes. Rather than optimizing the compression of human speech to be received and recognized by another human, some services would prefer and benefit from a codec that compresses the audio with express purpose of being interpreted by a computer

For example, businesses that offer customer services-such as financial institutions, airlines and government agencies-increasingly employ “automated attendants” to interact with and service customers over the phone. Automated attendants and similar mechanized services are driven by speech recognition systems. While speech recognition systems can accurately interpret high quality audio, the compression schemes currently employed on mobile phones and other wireless stations, although reasonably good for human listeners, often output audio data that does not have sufficient fidelity and clarity for computer translation. This can adversely impact the ability of speech recognition systems to decode such transmissions with precision. The resulting customer experience is often frustrating from the perspective of the customer because of the inability of the speech recognition system to understand their speech. In order to address these needs and better serve their customers, companies offering applications and services on mobile devices require solutions that provide alternative methods for handling the varying factors that impact sound quality—specifically, how the human voice is compressed and transmitted.

Codecs that are optimized speech that is delivered to another persons is often ill-suited for the purpose of recording, compressing and sending music, or for transmitting music in real-time. When these codecs are employed for these purposes, they produce poor sound quality. The poor sound quality of music data can result from the system's assessment of incoming audio to determine whether sound quality would be improved by engaging noise cancellation software or filters. In some cases, mobile communication devices feature built-in noise suppression software that boosts the quality of voice audio while selectively construing music as “background noise” and discarding it. Relying on a software program to judge whether sound is “noise” can have dubious results, especially when the audio being received is music.

The ability to transmit music using mobile communication devices spawned a service business where customers use their mobile devices to transmit music to a company that provides the service of music identification. For example, the company may require the user to hold a communication device such as a mobile telephone close to the source of the music, and then transmit the music the company. The service cross references the incoming music against its database, identifies the submitted track, and sends a text message to the mobile device user with the names of the song and the artist. To be successful, the quality of the music transmission sent by the customer to the service must be high enough so that the audio can be recognized by the automatic recognition service. If the codec used by the sender device interprets the music to be transmitted as background noise and therefore suppresses and discards it, the recipient service may have difficulty accurately identifying the music consistently. The ability of a company that provides song identification services is therefore compromised when the codecs engaged to compress music interpret the music as background noise and suppress it. Thus, the inflexible and unnuanced application of codecs on mobile device limits the scope and performance of wireless applications and services.

The sub-optimal audio produced by today's codecs can lead to a poor user experience and dissatisfaction with voice or music recognition systems. Furthermore, the underlying technology for sending and receiving various types of audio from today's mobile communication devices is inflexible, inadequate, and not optimized for the different types of services and applications in demand by the users of such devices.

### SUMMARY OF THE INVENTION

The present invention is directed to systems and methods for enabling the selection of the optimal compressor/decompressor (codec) on device such as a mobile communications device, in consideration of the intended recipient, the type of audio being sent, and/or whether the audio is transmitted in real-time or—as in instant voice messages—recorded prior to transmission. In addition, the invention provides for real-time codec selection during a communication with the recipient.

A codec is a technology used for compressing and decompressing data. The codecs typically deployed on wireless communication devices use algorithms that are optimized for encoding human speech in real-time, but which may produce poor quality for non-voice data, and are not optimized if the real-time requirement is removed. In addition, computers that perform speech recognition functions such as speech to text use different components of the audio stream for recognition than humans do.

According to the present invention, methods for intelligently choosing the appropriate codec solve these problems and provide for optimizing sound quality for specific situations, applications and parameters as audio data transmitted from a mobile communication device is compressed.

Intelligently selecting codecs makes it possible for a system or device to use an encoding scheme optimized for the audio type or the intended recipient. When the system determines that the audio data will be sent to a computer, the system can select a codec optimized for recognition software. When the system of the invention determines that the audio to be transmitted is music data, it selects a codec well-suited for music. In one embodiment\, music data may compressed for a recipient that is a machine, and embodiments of the invention provide for the device to select a codec best suited for this purpose.

In one embodiment, a sender device may operate in a wireless communication system such as a cellular telephone network or an IP based network. In these system, audio data is often compressed before being transmitted to the recipient. In one exemplary method, the audio data is typically received at the sender device. In some instances, the audio data is received and recorded before the recipient is identified.

Next, a codec is selected from one of the codecs available to the device. Factors influencing the selection of the codec can include, a type of the audio data (voice, music, etc.), whether the audio data is to be transmitted to the recipient in real time or recorded and then sent asynchronously, and/or characteristics of the recipient. This information can be collected from the recipient's previous messages, from synchronization processes, or from information stored on the device itself. In this manner, the codec selected to compress the audio data is based on factors that improve the quality of the transmission and make the audio data better for the recipient. For example, a service that identifies music would like to receive audio data that has been encoded with a codec optimized for music rather than a codec optimized for speech. Similarly, a voice recognition system would like to receive audio data that has been encoded with a codec optimized for speech recognition rather than human speech or music.

After the codec is selected, the audio data is transmitted to the recipient. The transmission of the data can be in real time or asynchronous. Also, the selected codec can be changed during communication. In this case, the recipient or another component involved in the transmission of the audio data may notify the sending device of the type of recipient. This information can be used to select a more suitable codec. For example, a recipient can proactively emit a tone that may be received by the sending device and associated with the codec that is suitable for the recipient.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order that the manner in which the advantages and features of the invention are obtained, a particular description of the invention will be rendered by reference to specific embodiments thereof which are illustrated in the appended drawings. Understanding that these drawings depict only typical embodiments of the invention and are not, therefore intended to be considered limiting of its scope, the invention will be described and explained with additional specificity and detail through the use of the accompanying drawings in which:

FIG. 1 is a block diagram illustrating a wireless data network in which the voice messaging systems of the invention can be practiced;

FIG. 2 illustrates another exemplary wireless data network in which embodiments of the invention may be practiced;

FIG. 3 is a block diagram illustrating one embodiment of a device that selects a codec based on the recipient, whether the data is sent in real-time or asynchronously, and/or the type of audio data being transmitted to the recipient;

FIG. 4 is an exemplary flow diagram illustrating the selection of a codec in consideration of the recipient;

FIG. 5 is a block diagram illustrating an embodiment where the recipient indicates which codec should be used in the compression of the audio data.

### DETAILED DESCRIPTION OF THE PREFERRED EMBODIMENTS

The present invention is directed to systems and methods to improve audio quality in wireless communication systems, by intelligently selecting the optimal compression/decompression technology in consideration of the intended recipient, the type of audio data being transmitted and/or whether compression and transmission is in real time or is recorded and then sent asynchronously. The codec can be selected by the device and/or by other network components that are involved in the transmission of the audio. In some instances, the choice of codec can be initiated by the recipient device. As used herein, the terms “codec” and “codec module” are used interchangeably, and refer to an audio processing module that may be implemented in software, hardware, or a combination thereof. While a single codec module residing on a wireless communication device can often perform both compression and decompression, the terms “codec” and “codec module” also extend to processing modules that perform, for example, only compression at a wireless communication device on audio data that is later to be decompressed at a recipient device.

### I. Operating Environments within Wireless Communication Systems

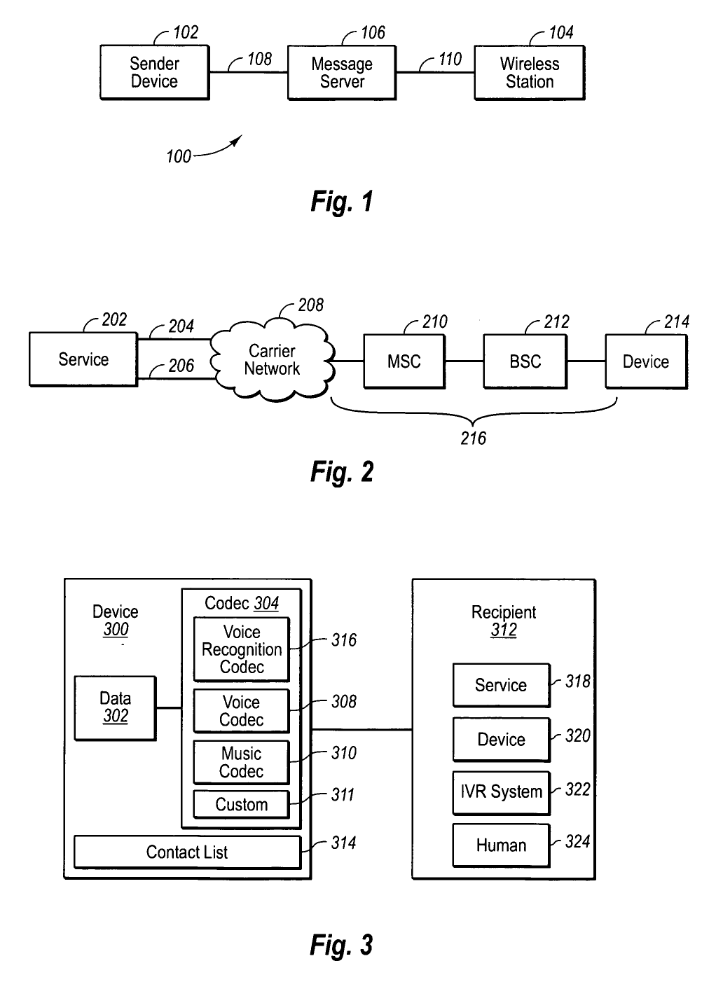

FIG. 1 is a block diagram illustrating an example of a wireless communication system in which embodiments of the invention can be practiced. Wireless communication system 100 includes a sender device 102 that may be used to create and transmit a voice message that is addressed to a recipient wireless station 104. The sender device 102 can be a wireless or mobile telephone, a conventional wired telephone, or any other telephony device. In general, sender device 102 can be any device that is capable of receiving and capturing audio data that forms the body of the message. The sender device 102 is also capable of receiving or of providing addressing information that identifies the recipient or the recipient wireless station 104 associated with the recipient. Instead of being a dedicated telephony device, sender device 102 can also be a personal computer or other computing devices having the foregoing capabilities.

In the embodiment of FIG. 1, sender device 102 communicates with a message server 106 using wireless network 108. In general, however, sender device 102 can communicate with message server 106 using any suitable communication network or mechanism, another example of which is the Public Switched Telephone Network (PSTN). Message server 106 may be a computer system that routes the voice message and performs the other operations described herein. The network 108 represents the various networks that enable the sender device 102 to connect with the message server 106. The network 108 therefore represents both digital and analog networks as well as hybrid networks. The connection 110 used by the message server 106 to communicate with the wireless station 104 can be similar to the network 108. In this example, the wireless station 104 refers to the combination of handset, base station, and MSC components which together perform the over-the-air codec functions and output TDM encoded audio.

It should be understood that the invention can be implemented in many types of network environments and various network architectures are applicable. In one embodiment, the message server 106 includes an SMS blade that resides in a wireless operator's network infrastructure. In another embodiment, the message server 106 and the SMS blade reside outside the domain of a wireless operator's infrastructure, and may be hosted, for example, by an independent hosting entity, such as an application service provider. Alternately, the message server 106 and the associated SMS blade can reside behind a corporate firewall.

FIG. 2 illustrates another exemplary environment for implementing embodiments of the invention. In FIG. 2, the carrier network 208 represents the wireless network used by a carrier. The connection 216 between the carrier network 208 and a device 214 such as a telephony device is typically digital in nature. The connection 216 may include a mobile switching center (MSC) 210 and a base station controller (BSC) 212. The transmission of data to/from the device 214 and the carrier network 208 is digital in nature.

The carrier network 208 may also establish a connection with an other entity such as a service 202. The connection between the carrier network 208 and the service 202 (or other entity or device) may occur over a digital connection 206 or over an analog connection 204 such as a PSTN connection. The digital connection 206 may be used, for example, for data messaging, while the connection 204 may be used for voice connections.

Embodiments of the invention enable the device 214, the service 202 or any of the various components involved in the communication between the device 214 and the service 202 to select a codec. The selection of the codec can be based, by way of example, on the recipient, whether the data is transmitted in real time, whether the data is recorded and later sent asynchronously, or the type of data being transmitted. Examples are discussed below.

### II. Codec Selection Processes

In one embodiment as illustrated in FIG. 3, the device 300 recognizes when audio data 302 is recorded prior to transmission and is able to take advantage of non-real-time compression techniques that provide superior sound. In this case, the device 300 records the audio data 302 in raw form and saves it on the device 300 in high quality format. Because the real-time encoding restriction is removed in this example, the saved audio data 302 is intelligently compressed by selectively employing the codec 304 that is optimal for the type of audio data 302 that has been recorded, or for the intended recipient(s) 312 when this becomes known to the sending device 300. Exemplary recipients 312 include, but are not limited to, a service 318 such as a music recognition service, a device 320, an voice recognition system 322, and a human 324. The data 302 is representative of the different types of audio data that can be recorded and/or transmitted by the device 300. The data 302 may be, by way of example, voice data, voice message, music data, etc.

For example, a user of the device 300 creates an instant voice message (represented by the data 302) and initiates delivery of the voice message to a human recipient 324 or device 320 that may be associated with the recipient 324 by choosing the recipient's name from a contact list 314. The user then records and sends the message via email. The voice message can be recorded and then sent asynchronously or the voice message can be encoded and transmitted in real time. The choice of codec 304 may be determined by the recipient 324 selected from the contact list 314. In this case, the device 300 can select a codec 308 that is optimized for compressing audio for recognition by a human recipient 324. However, the device 300 can also take into consideration the method of conveyance. In this scenario, where the audio data 302 is intended to be recorded, transmitted, received and interpreted by another person, the real-time requirement necessary for phone calls but not required for asynchronous transmission has been removed, and the system of the invention is able to choose a codec 304 that optimizes taking into account these additional degrees of freedom. Exemplary codecs include, but are not limited to, a voice recognition codec 316, a voice codec 304, a music codec 310, and a custom codec 311.

In another example illustrating codec-selection based on the recipient selected, the device 300 may engage a codec 304 based on its ability to encode the sender's outgoing audio in a manner best understood by a recipient service 318 or application that employs automated speech recognition such as the recipient 322. Many application and service businesses employ computerized voice or music recognition software to manage and process incoming customer requests. For companies that employ voice recognition, the use of the codec 316 which is optimized for voice recognition systems, is business-critical because they may not be able to satisfy customers if their voice recognition systems are consistently unable to correctly construe their customers' requests. In cases where a wireless device user invokes one of these services requiring voice recognition, the device 300 can choose a codec 316 optimized for the capabilities of speech recognition software. Compression of sound based on the recipient may involve the use of the codec 310 when the recipient is a music-recognition service. In this case, the device 300 can choose a codec 310 optimized for compressing music for receipt by audio recognition software of the music recognition service 318.

A user of a mobile communication device may invoke any of a number of wireless applications and services by selecting an entry in a contact list or other menu on the device. For example, when the user installs a stock reporting application that responds to audio commands of company names by providing their current stock prices, the fact that a codec suitable for computer recognition of speech should be used during the interaction is noted along with the phone number or other address, e.g. an email address, of the service. The device then chooses the appropriate codec.

In another embodiment of the invention, a wireless communication device 300 selects a codec dynamically during a phone conversation. For example, in the stock application mentioned previously, a user can call his or her stock broker, and then during the call be transferred to the stock pricing service, which may be represented by the recipient 322 as the service employs voice recognition. In this case, the computer of the recipient 322 that does the voice recognition emits a special tone that the device 300 recognizes. The device 300, upon recognizing the special tone from the recipient 322, switches to or selects a codec 304 suitable for computer speech recognition. In this example, the tone emitted by the recipient 322 causes the device 300 to select the codec 304, which is optimized for speech recognition systems.

In another example, the selecting 402 the recipient may occur after the receiving 404 the audio data. In this case, the identify of the recipient is unknown when the audio is initially received and recorded. Alternatively, the recipient can be selected before receiving the audio, yet the preferred codec is unknown. The audio data may be recorded in a raw form and then encoded when the preferred or best codec for the recipient becomes known. As previously indicated, the preferred codec may become known when the recipient is selected from a contact list that includes this information.

In another example, the user of a wireless station may subscribe to a service that employs a speech recognition interactive voice response (IVR) system. When the user sends a request to this service, the IVR server responds by returning a DTMF tone to the user.) Dual-tone multi-frequency (DTMF) is a mature technology typically used in remote control applications that employ touch tone telephones to transmit the tones. In this case, the client/wireless station software recognizes this DTMF tone as an instruction to modify the audio processing to support the particular requirements of the recipient IVR. The device or the wireless station can then compress the message using a codec appropriate for a computerized voice recognition system.

In another example, the client or device may receive a tone that indicates that music is being transmitted, the client or device turns off noise cancellation, allowing it to better compress and transmit music. Additionally, the tone could instruct the client or device to use higher quality audio such as a higher bit rate in the codec. This may involve encoding and then sending the data using some alternative means such as DTMF tones, modem tones, or transmitting the data to a different location, which is determined through a handshake. Items such as bit rate requirements, codec selection, and the like can be negotiated. In addition, the selection of a particular codec may also be dependent on the ability of the recipient to support the selected codec.

Wireless stations that do not support the codec selection techniques described herein would simply ignore the tone and continue on as before. Thus, this technique provides better quality for those wireless stations that support it, as well as continue to provide compatibility with existing wireless stations. Note, in the case of modifying the codec during a live telephone conversation or during another ongoing communication session as described herein, the term “wireless station” refers to the combination of handset, base station, and MSC components which together perform the over-the-air codec functions and output TDM encoded audio. With the techniques described herein, codec selection can be adjusted through tones or other means of encoding data from participating services.

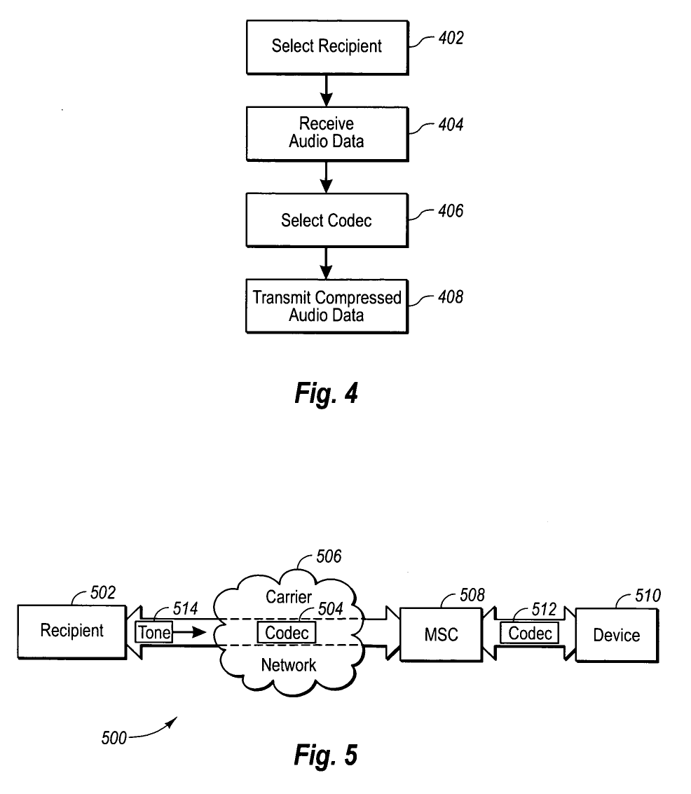

With reference to the network diagrams of FIGS. 1 and 2 and the flow diagram of FIG. 4, an embodiment of the methods for selecting a codec optimized for a recipient is illustrated. The recipient may be, for example, a wireless service that uses an IVR system. A device can engage the service via an instant voice message, then automatically compress and transmit the instant voice message. In this example, a sender selects 402 the recipient, which is a wireless service in this example, from a contact list or other menu of the sender's device. After selecting the recipient, the device receives 404 the audio data using, for example, a microphone in the device. The device then selects 406 the appropriate codec for the received audio data. Thus, the selection of the codec is performed in consideration of the recipient. In one embodiment, the selection of the codec can be performed using information associated with the selected recipient. For example, the contact list may indicate that the service selected by the device uses voice recognition. As a result, the selecting 406 the codec uses this information to select the codec that is optimized for voice recognition systems. In other words, when the sender device recognizes (via information stored along with the recipient in a contacts list) that the recipient is a computer that will perform voice-to-text translation or otherwise employ voice recognition, the sender device selects a codec optimized for computer voice recognition.

In some instances, the preferred codec of the recipient or other characteristics of the recipient may be unknown when the audio data is received or recorded. For example, receiving 404 the audio data may occur before selecting 402 the recipient. In this case, selecting 406 the audio may include determining the type of recipient (music recognition service, human, voice recognition system, etc.).

In another example, the selection of the optimal codec may be related to the type of audio data and whether the data is transmitted in real time or recorded and transmitted asynchronously.

With reference to FIG. 1 and FIG. 4, the device 102 then transmits 408 the compressed audio data over the network 108 to the message server 106. The message server then communicates with the service to permit the service to perform the voice recognition. Since the audio received by the service was compressed by the sender device using a codec optimized for that purpose, the accuracy of the voice-to-text function improves.

In the foregoing manner, audio can also be created, recorded and stored on a sender device, or transmitted in real-time, compressed using the optimal compression/decompression technology in consideration of the type of sound being recorded, then sent or transmitted in real-time and/or asynchronously to the intended recipient. The compressed audio data is sent over a wireless network via instant voice messages or transmitted live. The audio data can be accessed or received and decompressed by any new or legacy wireless station, application or service, regardless of the type of network, subscriber or member status, or type of sending device or receiving device or system.

FIG. 5 illustrates embodiments of the invention in a wireless voice network 500. In this example, the device 510 is sending audio data to a recipient 502. The data can be send in real time, or recorded and sent asynchronously as previously described. In this example, the recipient 502 emits a tone 514 that is conveyed back over the carrier network 506 to the MSC 508 and/or to the device 510. The tone 514 can convey information or can be used to access information related to the transmission of the audio data. The tone 514, for example, may indicate that the recipient 502 is a certain type that would benefit from the use of a specific codec. The tone 514 may also be used to provide other specifications such as bit rate or sample rate for use in the compression and transmission of the audio data.

In response to the tone 514, the device 510 itself can initiate the use of the preferred codec. Alternatively, the MSC 508 can instruct the device 510 to use a particular codec. As a result, the codec 504 and 512 used in transmission of the data from the device 510 to the recipient 502 is optimized for the recipient 502. In this case, the codec used in the transmission from the recipient 502 to the MSC 508 or the device 510 as well as the codec used in the transmission of data from the MSC 508 to the device 510 is not necessarily the same codec being used by the device 510. Often, the codec used from the MSC 508 to the device 510 does not change.

Another aspect of the invention entails mechanisms by which the device obtains the information for optimal codec selection. In one embodiment, this is stored along with the contact information of the destination as described previously. The preferred codec can be sent up as additional information during a contact synchronization service in which the server augments the contact in the user's contact list with the additional information about the preferred codec.

Information regarding the preferred codec can also be send to the sending device from the recipient. For example, the recipient may send the sending device a voice instant message. In such voice messages, the preferred codec can be encoded in one of the header fields of the message. The preferred codec can then be stored by the sender device and used in future communications with the recipient.

In one embodiment, Session Initiation Protocol (SIP) signaling and Voice over Internet Protocol (VoIP) telephony can be used during the call initiation sequence for real-time communications by allowing both sides to negotiate codec selection via Session Description Protocol (SDP) as part of the call establishment process (SIP RFC 3261, and SDP RFC 2327). Embodiments of the invention provide codec optimization for audio messaging services as well as non-SIP initiated mobile phone calls.

This information regarding the preferred codec may also be obtained by recording it during some other interaction with the device such as an SIP-initiated VoIP call. In such cases, the SIP protocol can be used to negotiate optimal codecs for a real-time communication sessions. This codec can be used in future communications.

### III. EXAMPLES

While embodiments of the invention are described in detail herein, the invention can be further illustrated by presenting specific examples of how the methods of intelligent codec selection can be applied. It is noted that the following examples are presented only to illustrate the invention, and the specific implementations and examples described hereinafter do not limit the scope of the invention.

In one embodiment, the user of a mobile communication device subscribes to a stock quote service that employs an IVR to manage incoming calls. The user selects a stock quote service from her mobile phone contact list, and clicks on a soft key to invoke the service. This launches the interface of the stock quote service, which instructs the user to say the company name or stock symbol. In the example, the user of the device speaks the company name, “Martha Stewart.” Additional information is included along with the address or phone number of the stock quote service. The additional information indicates that the stock quote service uses an automated system that employs speech recognition to interact with its customers. As a result, the device intelligently selects the optimal codec for voice compression to allow the stock quote service to easily decompress and recognize what the user is saying. Alternatively, if the codec selection information is not included along with the address, the stock service emits a special tone that the device recognizes. The device, upon recognizing the tone, switches to or employs a codec optimized for computer speech recognition as indicated by the tone.

In a second example, the stock quote service is implemented as a messaging service rather than as a dial-in phone service. In this case, the fact that the messaging services uses speech recognition is encoded in the contact list. When the user records and sends a message to retrieve a stock quote, the sending device employs the appropriate codec.

In a third example also using a wireless data network, both the sender and the recipient are humans and the instant message being recorded and transmitted is the human voice. The recipient device is connected to the telephone network via a carrier, which may use the AMR codec to decompress incoming transmissions. The sender's service uses the EVRC codec. The contact list of the sender includes the fact that the recipient device is optimized for AMR. This additional information can be determined in a number of ways including through a sync service that updates names and phone numbers, or recorded from a previous interaction with that user where the AMR codec was used, such as during a SIP initiated VoIP call or as part of a message header from the other user.

The device can achieve intelligent optimizations heretofore unavailable. In this case, rather than transmit the audio in EVRC format and suffer the ensuing data degradation due to conversion in the network or on the recipient device, the system of the sending device encodes the audio data directly to AMR. This encoded data is then transmitted to the recipient device, where it can be immediately decompressed by the system of the recipient station, thus avoiding conversion and subsequent quality loss.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

We claim:

1. In a wireless sender device operating in a wireless communication system in which audio data is compressed and transmitted from the sender device to a recipient, a method of selecting a codec for compressing the audio data, the method comprising:
receiving, at the sender device, audio data that is to be transmitted to an identified recipient;
selecting a codec from among a plurality of available codecs, wherein selecting the codec is based on at least one of the factors:
a type of the audio data;
characteristics of the recipient; or
whether the audio data is to be transmitted to the recipient in real time or recorded and transmitted asynchronously;
compressing the audio data using the selected codec; and
transmitting the compressed audio data from the sender device to the recipient.

2. The method of claim 1, further comprising, prior to selecting the codec, obtaining information locally at the sender device regarding the characteristics of the recipient, such that the codec is selected based at least on the characteristics of the recipient.

3. The method of claim 2, wherein the information regarding the characteristics of the recipient is stored in a contacts list stored on the sender device, wherein the information regarding the characteristics of the recipient include a codec associated with the recipient.

4. The method of claim 3, further comprising obtaining the information regarding the characteristics of the recipient comprises receiving the information from a synchronization service.

5. The method of claim 2, wherein obtaining the information regarding the characteristics of the recipient comprises obtaining the information from a previous interaction between the sender device and the recipient.

6. The method of claim 5, further comprising obtaining the information from a previous interaction that includes a Voice over Internet (VoIP) call between the sender device and the recipient.

7. The method of claim 5, further comprising obtaining the information from a previous interaction in which the sender device received a message with a message header that included the information.

8. The method of claim 1, wherein the selected codec does not perform noise cancellation.

9. The method of claim 8, wherein the audio data includes at least one of music data or voice data.

10. The method of claim 1, further comprising, prior to selecting the codec, analyzing content of the audio data received by the sender device, such that the codec is selected based at least on the type of the audio data.

11. The method of claim 10, wherein analyzing content of the audio data comprises recognizing that the audio data includes music data.

12. The method of claim 1, wherein selecting a codec from among a plurality of available codecs, is performed in response to user input identifying the codec to be selected.

13. The method of claim 1, wherein transmitting the compressed audio data from the sender device to the recipient further comprises recording the audio data and transmitting the audio data asynchronously.

14. The method of claim 1, wherein selecting a codec from among a plurality of available codecs further comprises selecting a particular codec that requires processing time that would not permit the particular codec to be used if the audio data were compressed and transmitted in real time.

15. In a wireless sender device operating in a wireless communication system in which audio data is compressed and transmitted from the sender device to a recipient, a method of selecting a codec for compressing the audio data, the method comprising:
receiving, at the sender device, audio data that is to be transmitted to an identified recipient;
receiving, at the sender device, a tone from the recipient, wherein the tone specifies a codec used by the recipient;
in response to receiving the tone, selecting the specified codec at the sender device from among a plurality of available codecs and using the specified codec to compress the audio data; and
initiating transmission of the compressed audio data from the sender device to the recipient.

16. The method of claim 15, wherein receiving, at the sender device, a tone from the recipient further comprises receiving a tone indicating that the recipient includes an interactive voice response (IVR) system.

17. The method of claim 15, wherein receiving, at the sender device, a tone from the recipient further comprises receiving a tone indicating that the recipient includes a computerized voice recognition system.

18. The method of claim 17, wherein receiving, at the sender device, a tone from the recipient further comprises receiving a tone indicating that the codec specified by the tone is optimized for permitting the computerized voice recognition system to process the audio data.

19. The method of claim 15, further comprising:
receiving the tone during an ongoing communication session between the sender device and the recipient; and
selecting the specified codec includes discontinuing use of a previously used codec and initiating use of the specified coded during the ongoing communication session.

20. The method of claim 19, wherein selecting the specified codec further comprises:
discontinuing use of a previously used codec; and
initiating use of the specified codec during the ongoing communication session.

21. The method of claim 19, wherein:
a first portion of the ongoing communication session includes communication to a human recipient;
a subsequent second portion of the ongoing communication session includes communication to a voice recognition system associated with the recipient; and
the tone is received in response to initiation of the second portion of the ongoing communication session.

22. The method of claim 15, wherein the codec specified by the tone is associated with a bit rate that is higher than a bit rate of another codec that would have been used by the sender device in the absence of receiving the tone.

23. The method of claim 22, wherein initiating transmission of the compressed audio data comprises initiating transmission of the compressed audio data using at least one of:
a data channel of the wireless communication system;
Dual-Tone Multi-Frequency (DTMF) tones; or
modem tones.

24. The method of claim 22, wherein initiating transmission of the compressed audio data further comprises initiating transmission of the compressed audio data to a specified network location that has been determined using a handshake procedure between the sender device and the recipient.

25. In a system including a wireless network, a method for transmitting data from a sender device to a recipient, the method comprising:
receiving audio data at the sender device, wherein the audio data is to be transmitted to a recipient;
collecting information used to select a codec for compressing the audio data;
selecting a particular codec based on the collected information; and
transmitting the compressed audio data to the recipient.

26. The method of claim 25, wherein collecting information used to select a codec further comprises one or more of:
receiving a tone generated by the recipient that identifies the particular codec;
identifying previous messages from the recipient to identify the particular codec;
determining a type of audio data;
determining whether the audio data is to be transmitted in real time or to be recorded and transmitted asynchronously; and
accessing a contact list to identify the particular codec associated with the recipient.

27. The method of claim 25, wherein transmitting the compressed audio data to the recipient further comprises one or more of:
recording the audio data;
transmitting the audio data asynchronously; and
encoding the audio data with the particular codec in real time and transmitting the audio data in real time.

28. The method of claim 25, further comprising changing to a new codec in response to a tone from the recipient.

29. The method of claim 25, wherein receiving audio data further comprises recording raw audio data.
